(19) United States
(12) Patent Application Publication
(10) Pub. No.: US 2005/0015506 A1
(43) Pub. Date: Jan. 20, 2005

(54) System and method for anonymous information exchange

(76) Inventor: Kristian Padborg, Emeryville, CA (US)

Correspondence Address: BLACK LOWE & GRAHAM, PLLC, 701 FIFTH AVENUE, SUITE 4800, SEATTLE, WA, 98104, US

(21) Appl. No.: 10/859,065

(22) Filed: Jun. 1, 2004

Related U.S. Application Data
(60) Provisional application No. 60/475,138, filed on May 30, 2003.

(51) Int. Cl. G06F 15/16; G06F 17/30; G06F 7/00; G06F 12/00

(52) U.S. Cl. 709/229; 709/204; 707/3

(57) ABSTRACT

A method for facilitating an exchange of information anonymously comprising one or more individuals registering with a server and supplying information about one or more other individuals or entities in the form of a report that is stored on the server. Users of the system then search the reports for information about the one or more other individuals or entities. After completing a search, users receive the information about the one or more individuals or entities from the server and review the information to determine if contact should be made with the author of any of the reports. If such contact is desired the user through the system communicates anonymously with the author of any of the reports.

### STATEMENT OF RELATED CASES

This application claims priority to and incorporates by reference herein U.S. Patent Application Ser. No. 60/475,138.

### FIELD OF THE INVENTION

This invention relates generally to system and method for the exchange of information anonymously and, more specifically, to a system and method for making information concerning individuals and other entities available to exchange with others without having to exchange with the other party any personally identifiable information.

### BACKGROUND OF THE INVENTION

In business or personal transactions, the need for more information about the parties involved in the transaction has never been greater. The tremendous growth of the Internet and other communication devices has made global transactions ubiquitous but potentially unsafe. The information one would need to increase their confidence level in transacting global transactions of any kind often is not readily available. Typically, one would research a potential transactional partner by querying those having some specific knowledge of the new person or entity with whom a transaction is desired. But inherent in securing that research is first finding a person who has the information you desire and secondly, having that person trust you with that information, especially if that person does not desire that you know who they are.

Therefore, in today's world of far reaching transactional opportunities, a lack of information about the other party is a serious barrier to the confidence level the parties need to have in one another for a successful endeavor. Thus, there is a need for a system to collect and provide access to information about individuals that maintains the anonymity of the person reporting the information and the person securing the information.

### BRIEF DESCRIPTION OF THE DRAWINGS

The preferred and alternative embodiments of the present invention are described in detail below with reference to the following drawings.

FIG. 1 depicts a computer system of the present invention;

FIG. 2 illustrates a flow chart depicting a user entering an experience request in accordance with an embodiment of the present invention;

FIG. 3 illustrates a flow chart depicting a user searching for experience request information and interacting with other users in accordance with an embodiment of the present invention; and

FIG. 4 illustrates a flow chart depicting a user creating daily search requests for experience request information and interacting with other users in accordance with an embodiment of the present invention.

### SUMMARY OF THE INVENTION

The present invention comprises a system and method for the exchange of information anonymously. The present invention allows users to register with a server and supply information about one or more other individuals or entities, preferably in the form of a report that is stored on the server. Users of the system then search the reports for information about the one or more other individuals or entities. After completing a search, users receive the information about the one or more individuals or entities from the server and review the information to determine if contact should be made with the author of any of the reports. If such contact is desired the user through the system communicates anonymously with the author of any of the reports.

In accordance with further aspects of the invention, the supplying information that is stored on the server comprises the one or more users: entering into a web page information about one or more individuals of entities; and receiving from the server a confirmation that the information has been stored to the server.

In accordance with yet other aspects of the invention, a secure website (preferably but not necessarily accessible only to registered users) provides a central clearinghouse of information about persons or companies that can be consulted by users to help such users decide whether they wish to do business or have other kinds of dealings with such persons or companies.

In accordance with other aspects of the invention, the information that is stored on the server further comprises storing the information with at least one unique identification indicia for each report stored.

In accordance with still further aspects of the invention, the searching for the information comprises: entering on a form one or more search parameters; and sending the search parameters in a query to the server.

In accordance with still another aspect of the invention, the receiving the information about the one or more individuals or entities from the server comprises receiving the information in the form of an email.

In accordance with still further aspects of the invention, the email being embedded with one or more hyperlinks and the hyperlinks being linked by uniquely identifiable indicia to the report about the one or more individuals or entities. In accordance with yet another aspect of the invention, the information about the one or more individuals or entities comprises determining if an anonymous exchange of information is necessary or advisable.

In accordance with further aspects of the invention, communicating anonymously with the one or more individuals comprises composing an email to the one or more individuals.

In accordance with still further aspects of the invention, the email being sent to one or more individuals with no personally identifiable information of its author.

In accordance with additional aspects of the invention, the email being sent being embedded with one or more hyperlinks, the hyperlinks being further linked to a web page wherein a responding message is composed.

In accordance with still additional aspects of the invention, the email being received by one or more individuals with no personally identifiable information of its author.

In accordance with yet other aspects of the invention, information stored in the database comprises individual names, emails addresses or business names.

As will be readily appreciated from the foregoing summary, the invention provides a system and method for the exchange of information anonymously.

### DETAILED DESCRIPTION OF THE PREFERRED EMBODIMENT

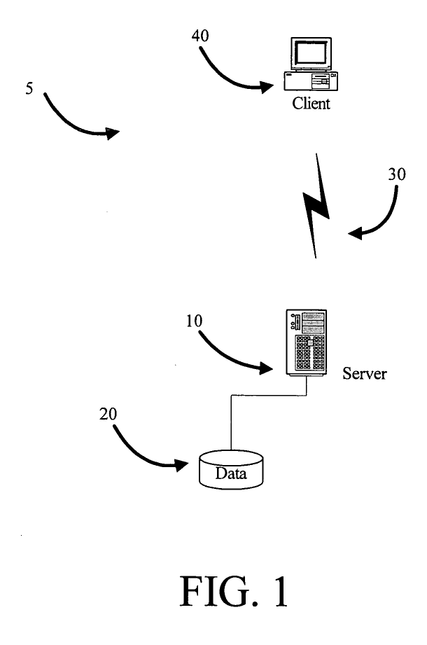

FIG. 1 illustrates an exemplary computer-based system 5 in a preferred embodiment of the present invention. In FIG. 1, a server 10 is connected via a network 20 to a client 40 that includes a display 30. The server 10 is a Web server or Internet site capable of executing program logic stored in the memory of the server 10 (not shown) and of sending graphical web pages to other computers over the network 20, including to the client 40. While the server 10 is preferably a Web server, it may alternatively be any type of server capable of being accessed over a wired or wireless network by a remote client computer. The server 10 includes a database 20 containing information along with other program logic in its memory useful to operate the system and allow users to interact with the system for anonymous information exchange. The information database 12 is preferably located within a memory (not shown) on the server 10, but may also be located on a remote memory coupled to the server 10. The memory may be any computer-accessible database, such as, for example, a magnetic hard drive, optical CD-ROM, magnetic tapes, RAM chips, or EEPROMs.

The client computer 40 is a remote computer that is coupled to the server 10 over the Internet. Remote association does not necessarily imply a great distance, but rather acknowledges that it will typically be a different computer than the server 10. In the preferred embodiment, the client 40 will be a home or office personal computer capable of accessing the server 10 over the Internet. Nonetheless, the client 40 may alternatively be any electronic device capable of accessing the server 10 over the network 20 including, for example, a wired or wireless television set-top box, “handheld” “palm-top” or “pocket type” pc or device, mobile phone, pager, or other device. Because portable computers, “palm-top” or “pocket type” pc or device, modems, phone lines, cell phones and other Internet-ready devices are widely available, the remote computer, or client 40, may be located anywhere that Internet access is available.

The client computer 40 includes a display 30 that is coupled to the client 40 and is capable of displaying the graphical web pages or other information downloaded from the server 10 and also includes a means for receiving communication from a user, for example via a coupled mouse or keyboard. The display 30 is a computer monitor of the type typically connected to a home or office computer. Alternatively, the display may include a television, LCD panel, or any other device capable of conveying electronic information received from the server 10.

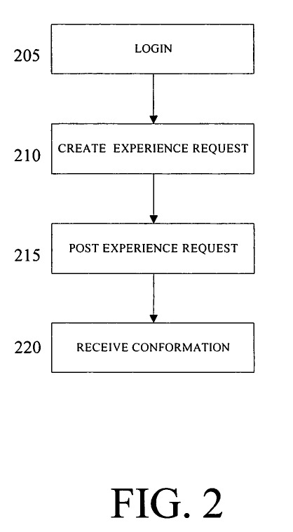

FIG. 2 is a flow chart depicting a user entering an experience request on the system for anonymous information exchange. An experience request is the information a user wishes to make anonymously available to other users. At block 205, a user logs into the main or “home” page on the server by entering an appropriate URL into an Internet browser or other commercially available software allowing Internet communication. A HyperText Markup Language (HTML) web page is sent to the client so that it may be viewed under the browser software. While HTML is the preferred format for transmitting information from the server 10 to the client 40, other formats are possible. The client 40 and server 10 may communicate using any of a variety of languages and data formats, for example Extensible Markup Language (XML). After accessing the home page, a user creates a registration whereby the user provides a username and country of origin, or any other information that is useful to allow the user to be identified to the server 10. In the preferred embodiment, the server 10 is configured to provide a temporary password for a first time registered user via return email. The password is preferably required to access the server 10. The server 10 is further configured to assign a unique identification number to each user of the system (Author_ID) who is registered to use the system. The Author_ID is stored on the information database 12 of the server 10.

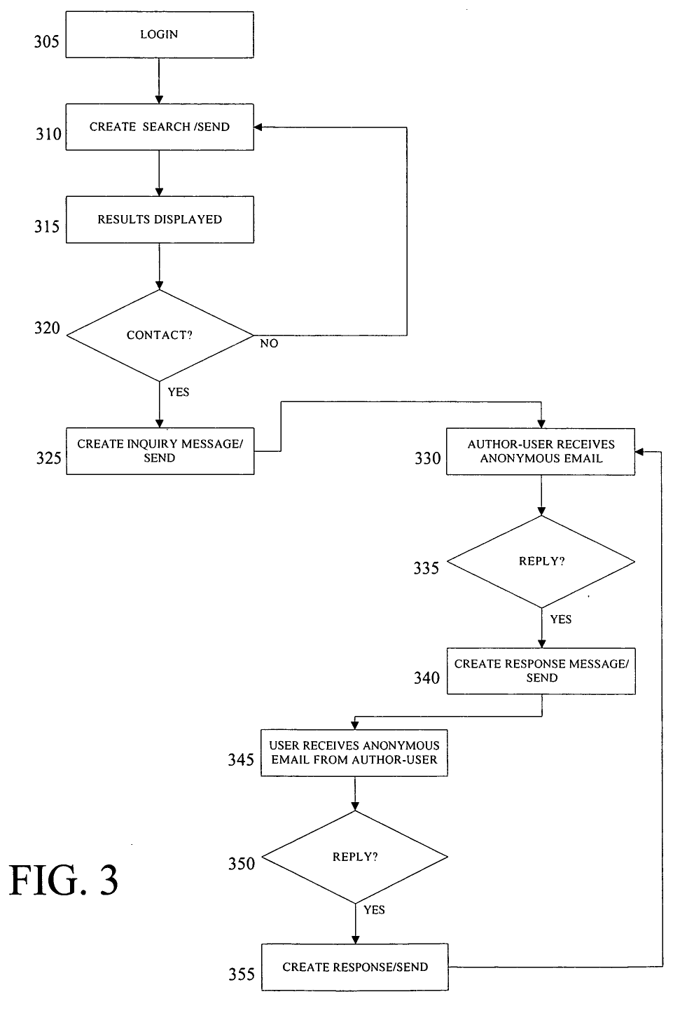

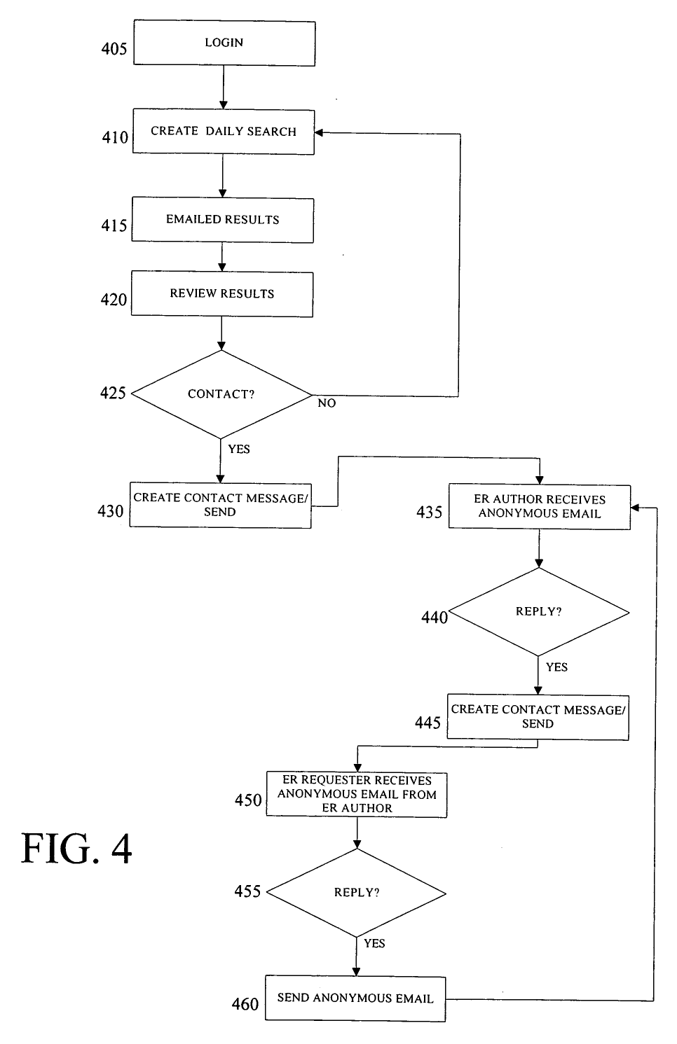

Once the server 10 has verified the user is registered, the user is presented on the client 40 display 30 a web page with various options for accessing other options of the system. Included is the option to submit experience request information on individuals or entities the user knows or has reason to know something about. After logging in at block 205, the user who wants to submit experience request information (now for purposes of clarity called an author-user) at block 210, fills outs an experience request form provided by the program logic of the system explaining within the form, for example, the relationship to the author-use has to a subject (the person or entity the subject of the experience request), what experiences have occurred with the subject, and other details depending on the subject of the experience request. In the preferred embodiment the subject of the experience request is based on a person's name, an email address or entity name but other experience request subjects are collectable including for example, information based on a subject address or a school. The collected experience request information is used by the system to later help a user to search the database 20 (illustrated at FIGS. 3 and 4) and identify with a higher degree of confidence that the person or entity they are looking for information on is indeed the person or entity for whom a report has been found. Once the user completes an experience request form, information in the form is stored to the information database 20 of the server 10 and each experience request submitted by the author-user is given a unique experience request identification number (Experience_request_ID) which is stored on the database 20 of the server 10. The program logic confirms receipt of the information at block 225 and sends a confirmation email confirming the content of the experience request information to the author-user who posted the experience report information.

FIG. 3 is a flow chart illustrating a user of the system for anonymous information exchange searching for experience request information and interacting with other users of the system. At block 305, the user logs on to the server 10. At this point, the user will preferably enter a username and password via an input device such as a keyboard. The program logic is configured to accept the user's login and password and verify that the user has access rights to the server 10. If the user enters a system verifiable username and password, the user is given access to the server 10. At block 310, the user accesses through the network 30 a web page on the server 10 that allows the user to enter and submit one or more search parameters that the program logic will use to search the experience request information that an author-user in FIG. 2 has entered and the program logic has saved to the system database 20. In the preferred embodiment, the search parameters include an individual's name, email address, or an entity name. The use of search parameters based on a person's name or email or an entity name in the preferred embodiment is not meant as a limitation on the types of information that can be collected and reported on by a user interacting with the system since any experience request information collected as illustrated in FIG. 2, can be made searchable by the program logic, for example a school name or street address. Once the user completes entering the experience request search parameters, the user submits the experience request search parameters to the server 10 at block 310. If the program logic is able to locate a match against information stored on the database 20 of the server 10 the server 10 returns to the user through the display of the client 40 at block 315 reviewable results in the form of a web page with hyperlinks to the one or more experience request reports. If more than one report is available from the database 20, at block 315, the user is provided the number of reports available and the user can choose to review each of them by clicking on the appropriate hyperlink. In the preferred embodiment the experience request report viewable at block 315 includes such information as a unique message ID, the date of the experience request information post, the subject of the experience request, an email address which was the subject of the search request, and other pertinent experience request information stored on the database 20 as posted by any author-user as illustrated in FIG. 2. For example other pertinent experience request information includes how well does the author-user know the subject, the author-user's relationship to the subject and when did the author-user's experience occur.

At decision block 320, the user will decide to contact the one or more author-users who submitted the experience request report as depicted in FIG. 2 for more information. If the user chooses not to make contact, the user can continue searching at block 310 or exit the system 5. Once an experience request report is identified as one the use would like more information about, the user at block 325, creates and sends an anonymous email to the author-user of one or more reports to further inquire about the subject of the report. The program logic is configured so that the author-user will receive the email message at block 330 from the server 10 (not directly from the inquiring user) over the network 30 without knowing the identity of the user who sent the inquiry. The body of this email message includes at least one hyperlink or equivalent that links via a unique message ID, for example the Experience_request_ID, to a web page stored on the database 20 of the server 10 that contains the experience request information. The inquiring user's email address does not appear anywhere on or in the email including within the message and headers. The text that the user entered into the web page will appear in the body of the email message along with other standard explanatory information. The author-user cannot respond to the email by using the reply-to button in an email program because the email message sent to the author-user by the system 5 does not contain a usable email address for that purpose.

At block 330, the author-user receives from the inquiring user the email message embedded with one or more hyperlinks. At decision block 335, the author-user decides to reply to the anonymous inquiry from the user, composes a reply to the inquiry and clicks the hyperlink where at block 340, a web page readily capable of receiving the author-user's reply is opened on the client 40 from which the author-user can enter a response to the user's inquiry and at block 340, click to send the response to the user. The program logic then queries the database 20 for the email address of the inquiring user and sends the author-user's email over the network 30 to the user at block 345. The author-user's email address does not appear anywhere on or in the email including within the message and headers. The text that the author-user entered into the web page will appear in the body of the email message along with other standard explanatory information. In the preferred embodiment, the user cannot respond to the email by using the reply-to button in an email program because the email message sent to the author-user by the system does not contain a usable email address for that purpose. (In alternate embodiments, reply can be enabled). At decision block 350, the user decides to either reply to the author-user's email or not and if the user decides to reply to the author-user's response then the user at block 355, responds to the author-user's response sent at block 340 by clicking on a hyperlink in the email message described at block 340 which hyperlink opens a web page on the client 40 readily capable of receiving the user's reply and at block 355, the user enters the reply to the author-user's response. This back and forth interaction can continue until users terminate communication or decide to reveal other personally identifiable contact means to each other like email address, telephone number, or similar contact information. The use of the particular ID elements in the preferred embodiment is not meant as a limitation on the system's ability to create other variably linked ID fields.

FIG. 4 illustrates a flow diagram of a user creating daily search requests for information and interacting with other users of the system for anonymous information exchange. At block 405, the user logs on to the server 10. At this point, the user will preferably enter a username and password via an input device such as a keyboard. The program logic is configured to accept the user's login and password and verify that the user has access rights to the server 10. If the user enters a system verifiable username and password, the user is given access to the server 10. At block 410, the user accesses through the network 30 a web page on the server 10 that allows the user to enter and submit search parameters that the program logic will use to search on a scheduled interval the experience request information that an author-user in FIG. 2 has entered and the program logic has saved to the system database 20. In the preferred embodiment, the search parameters include an individual's name, email address, or an entity name. The use of search parameters based on a person's name or email or an entity name in the preferred embodiment is not meant as a limitation on the types of information that can be collected and reported on by a user interacting with the system since any experience request information collected as illustrated in FIG. 2, can be made searchable by the program logic, for example a school name or street address. Once the user completes entering the experience request search parameters, the user submits the experience request search parameters to the server 10 at block 310 where the search parameters are saved to the memory of the server 10. According to the schedule if the program logic is able to locate a match against records stored on the database 20 of the server 10 with either a user-supplied email address, person's name, or entity name the server 10 returns to the user through the display of the client 40 at block 415 an email message with one or more hyperlinks to the one or more experience request reports and the user can choose to review any of them by clicking on the appropriate hyperlink. If the user clicks on any of the hyperlinks, at block 420, a web page from the server 10 is displayed to the user at the client 40 with further hyperlinks to the one or more experience request reports available for review.

At decision block 425, the user will decide to contact the one or more author-users who submitted the experience request report as depicted in FIG. 2 for more information. Once the experience request report is identified, the user at block 430, creates and sends an anonymous email to the author-user of one or more reports to further inquire about the subject of the report. The program logic is configured so that the author-user will receive the email message at block 435 from the server 10 (not directly from the inquiring user) over the network 30 without knowing the identity of the user who sent the inquiry. The body of this email message includes at least one hyperlink that links via a unique message ID, for example the Experience_request_ID to a web page stored on the database 20 of the server 10 that contains the experience request information. The inquiring user's email address does not appear anywhere on or in the email including within the message and headers. The text that the user entered into the web page will appear in the body of the email message along with other standard explanatory information. In the preferred embodiment, the author-user cannot respond to the email by using the reply-to button in an email program because the email message sent to the author-user by the system 5 does not contain a usable email address for that purpose. (In alternate embodiments, such replies are enabled).

At block 435, the author-user receives from the inquiring user the email message embedded with one or more hyperlinks and at decision block 435, the author-user decides to reply to the anonymous inquiry from the user, composes a reply to the inquiry and clicks the hyperlink where at block 445, a web page readily capable of receiving the author-user's reply is opened on the client 40 from which the author-user can enter a response to the user's inquiry and at block 445, click to send the response to the user. The program logic then queries the database 20 for the email address of the inquiring user and sends the author-user's email over the network 30 to the user at block 450. The author-user's email address does not appear anywhere on or in the email including within the message and headers. The text that the author-user entered into the web page will appear in the body of the email message along with other standard explanatory information. Again, in the preferred embodiment, the user cannot respond to the email by using the reply-to button in an email program because the email message sent to the author-user by the system does not contain a usable email address for that purpose. At decision block 455, the user decides to either reply to the author-user's email or not and if the user decides to reply to the author-user's response then the user at block 460, responds to the author-user's response sent at block 445 by clicking on a hyperlink in the email message described at block 445 which hyperlink opens a web page on the client 40 readily capable of receiving the user's reply and at block 460, the user enters the reply to the author-user's response. This back and forth interaction can continue until users terminate communication or decide to reveal other personally identifiable contact means to each other like email address, telephone number, or similar contact information. The use of the particular ID elements in the preferred embodiment is not meant as a limitation on the system's ability to create other variably linked ID fields. While FIG. 4 illustrates a single search by a user, searches can be unlimited in both the type of experience requests searched and the number of searches a user may instigate.

Similar to the phenomenon of word of mouth reputation, it may be that some of the information submitted to the system is false. However, just as with word of mouth reputation, a user can take that possibility into account, and may nevertheless rationally conclude, for example, that if there are 25 “negative” sorts of reports about a person or company in the system, that it might not be safe to deal with such person or company without further assurances, or to inquire as to the specifics of the experience to ascertain whether the reported experience is indicative of future experiences or behavior. Unlike mere word of mouth transmission of such information however, it can be submitted anonymously (which can tend toward candor), and can be aggregated across populations of strangers (for a larger, and possible statistically more meaningful data sample) to a degree that is much more difficult or impossible with mere word of mouth transmission of reputation information.

While the preferred embodiment of the invention has been illustrated and described, as noted above, many changes can be made without departing from the spirit and scope of the invention. For example, while the preferred embodiment illustrates using a server-client system to store and provide anonymous information to a user, other systems can be used to provide the anonymous information without relying on a permanent storage system in a server-client environment, for example a peer-to-peer network or an application service provider.

In another embodiment of the system alternative means for the anonymous exchange of information is provided, for example via instant messaging or any other means for exchanging electronic information.

In yet an alternative embodiment of the system, a user not only provides information to create reports on subjects as illustrated by FIG. 2, but also attaches documents like criminal reports, employment reports, resumes, and photos and makes them available to the search and reporting function of the present invention.

Accordingly, the scope of the invention is not limited by the disclosure of the preferred embodiment.

1. A method for facilitating an exchange of information anonymously comprising one or more individuals:
collecting anonymous information in the form of a report that is stored on a server;
enabling users to search the reports for information about one or more individuals or entities; and
displaying the information about the one or more individuals or entities from the server in response to the search.

2. The method of claim 1 wherein the registering with the server comprises:
(a) determining whether the one or more individuals has provided a valid logon and password;
(b) if the one or more individuals has not provided a valid logon and password, authorizing a logon and password unique to the user; and
(c) registering the logon and password unique to the user with the server.

3. The method of claim 1 wherein the supplying information that is stored on the server comprises the one or more users:
(a) entering into a web page information about one or more individuals of entities; and
(b) receiving from the server a confirmation that the information has been stored to the server.

4. The method of claim 3, wherein the information that is stored on the server further comprises storing the information with at least one unique identification indicia for each report stored.

5. The method of claim 1, wherein the searching for the information comprises:
(a) entering on a form one or more search parameters; and
(b) sending the search parameters in a query to the server.

6. The method of claim 1, wherein the receiving the information about the one or more individuals or entities from the server comprises receiving the information in the form of an email.

7. The method of claim 6 further comprising the email being embedded with one or more hyperlinks.

8. The method of claim 7 further comprising the one or more hyperlinks being linked by uniquely identifiable indicia to the report about the one or more individuals or entities.

9. The method of claim 1, wherein the reviewing the information about the one or more individuals or entities comprises determining if an anonymous exchange of information is advisable.

10. The method of claim 1, wherein communicating anonymously with the one or more individuals comprises composing an email to the one or more individuals.

11. The method of claim 10 further comprising the email being sent to one or more individuals with no personally identifiable information of its author.

12. The method of claim 10 further comprising the email being sent being embedded with one or more hyperlinks.

13. The method of claim 12 further comprising the one or more hyperlinks being linked to a web page wherein a responding message is composed.

14. The method of claim 10 further comprising the email being received by one or more individuals with no personally identifiable information of its author.

15. The method of claim 1, wherein information stored in the database comprises individual names, emails addresses or business names.

16. A system for facilitating an exchange of information anonymously between one or more individuals, comprising:
means for supplying anonymous information in the form of a report that is stored on a server;
means for searching the reports for information about one or more individuals or entities; and
means for receiving the information about the one or more individuals or entities from the server.

17. A system for facilitating an exchange of information anonymously between one or more individuals, comprising:
a server; and
a memory connected to said server and storing a program for controlling the operation of said server and storing the information;
said server with said program logic in said memory to:
register the one or more individuals;
supply information in the form of a report that is stored on the server;
search the reports for information about one or more individuals or entities;
receive the information about the one or more individuals or entities from the server;
review the information the information about the one or more individuals or entities; and
communicate anonymously with the one or more individuals

18. The system of claim 17 wherein the registering with the server comprises:
(a) determining whether the one or more individuals has provided a valid logon and password;
(b) if the one or more individuals has not provided a valid logon and password, authorizing a logon and password unique to the user; and
(c) registering the logon and password unique to the user with the server.

19. The system of claim 17, wherein the supplying information that is stored on the server comprises the one or more users:
(a) entering into a web page information about one or more individuals of entities; and
(b) receiving from the server a confirmation that the information has been stored to the server.

20. The system of claim 19, wherein the information that is stored on the server further comprises storing the information with at least one unique identification indicia for each report stored.

21. The system of claim 17 wherein the searching for the information comprises:
(a) entering on a form one or more search parameters; and
(b) sending the search parameters in a query to the server.

22. The system of claim 17 wherein the receiving the information about the one or more individuals or entities from the server comprises receiving the information in the form of an email.

23. The system of claim 22 further comprising the email being embedded with one or more hyperlinks.

24. The system of claim 23 further comprising the one or more hyperlinks being linked by uniquely identifiable indicia to the report about the one or more individuals or entities.

25. The system of claim 17, wherein the reviewing the information about the one or more individuals or entities comprises determining if an anonymous exchange of information is advisable.

26. The system of claim 17, wherein communicating anonymously with the one or more individuals comprises composing an email to the one or more individuals.

27. The system of claim 26 further comprising the email being sent to one or more individuals with no personally identifiable information of its author.

28. The system of claim 26 further comprising the email being sent being embedded with one or more hyperlinks.

29. The system of claim 28 further comprising the one or more hyperlinks being linked to a web page wherein a responding message is composed.

30. The system of claim 17 further comprising the email being received by one or more individuals with no personally identifiable information of its author.

31. The system of claim 17, wherein information stored in the database comprises individual names, emails addresses or business names.
